(19) United States
(12) Patent Application Publication
(10) Pub. No.: US 2026/0147499 A1
(43) Pub. Date: May 28, 2026

(54) HOUSEKEEPING FOR DATA CONTAINERS IN A DEDUPLICATION STORAGE SYSTEM

(71) Applicant: Hewlett Packard Enterprise Development LP, Spring, TX (US)

(72) Inventors: Richard Phillip Mayo, Bristol (GB); Andrew Skinner, Bristol (GB)

(21) Appl. No.: 18/959,908

(22) Filed: Nov. 26, 2024

(51) Int. Cl. G06F 3/06; G06F 16/16

(52) U.S. Cl. CPC G06F 3/0641; G06F 3/0626; G06F 3/0644; G06F 16/162

(57) ABSTRACT

Example implementations relate to operations in a storage system. An example includes loading a container index into memory to match against new data units to be stored in a storage system. The example also includes, in response to loading the container index into the memory to match against the one or more new data units: reading metadata in the container index to identify a container entity group (CEG) object stored in the storage system; identifying a subset of unreferenced data units; in response to a determination that a size of the subset of unreferenced data units is greater than a threshold, storing a subset of referenced data units in a pending CEG object loaded in the memory; and after storing the subset of referenced data units in the pending CEG object, deleting the identified CEG object from the storage system.

### BACKGROUND

Data reduction techniques can be applied to reduce the amount of data stored in a storage system. An example data reduction technique includes data deduplication. Data deduplication identifies data units that are duplicative, and seeks to reduce or eliminate the number of instances of duplicative data units that are stored in the storage system.

### BRIEF DESCRIPTION OF THE DRAWINGS

Some implementations are described with respect to the following figures.

FIGS. 1A-1B are illustrations of an example storage system, in accordance with some implementations.

FIGS. 2A-2B are illustrations of example data structures, in accordance with some implementations.

FIG. 3 is an illustration of an example process, in accordance with some implementations.

FIGS. 4A-4H are illustrations of example operations, in accordance with some implementations.

FIG. 5 is an illustration of an example operation, in accordance with some implementations.

FIG. 6 is an illustration of an example process, in accordance with some implementations.

FIG. 7 is a schematic diagram of an example computing device, in accordance with some implementations.

FIG. 8 is an illustration of an example process, in accordance with some implementations.

FIG. 9 is a diagram of an example machine-readable medium storing instructions in accordance with some implementations.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In some examples, a storage system may receive a data stream from an external data source or system, and may store or “backup” a copy of the data stream. For example, the data stream may be generated by a backup system or program during a backup of a collection of data. The data stream may include discrete data units (or “chunks”) that are generated by the data source. Further, in some examples, the storage system may backup at least a portion of the data stream in deduplicated form, to thereby reduce the amount of storage space occupied by storage of the data stream. The storage system may create a “backup item” to represent a data stream in a deduplicated form. The storage system may perform a deduplication process including determining “fingerprints” (described below) for the incoming data units. Further, the storage system may compare the fingerprints of incoming data units to fingerprints of stored data units, and may thereby determine which incoming data units are duplicates of previously stored data units (e.g., when the comparison indicates matching fingerprints). In the case of data units that are duplicates, the storage system may store references to previously stored data units instead of storing the duplicate incoming data units.

As used herein, the term “fingerprint” refers to a value derived by applying a function on the content of the data unit (where the “content” can include the entirety or a subset of the content of the data unit). An example of a function that can be applied includes a hash function that produces a hash value based on the content of an incoming data unit. Examples of hash functions include cryptographic hash functions such as the Secure Hash Algorithm 2 (SHA-2) hash functions, e.g., SHA-224, SHA-256, SHA-384, etc. In other examples, other types of hash functions or other types of fingerprint functions may be employed.

A “storage system” can include a storage device or an array of storage devices. A storage system may also include storage controller(s) that manage(s) access of the storage device(s). A “data unit” can refer to any portion of data that can be separately identified in the storage system. In some cases, a data unit can refer to a chunk, a collection of chunks, or any other portion of data. In some examples, a storage system may store data units in persistent storage. Persistent storage can be implemented using one or more of persistent (e.g., nonvolatile) storage device(s), such as disk-based storage device(s) (e.g., hard disk drive(s) (HDDs)), solid state device(s) (SSDs) such as flash storage device(s), or the like, or a combination thereof.

A “controller” can refer to a hardware processing circuit, which can include any or some combination of a microprocessor, a core of a multi-core microprocessor, a microcontroller, a programmable integrated circuit, a programmable gate array, a digital signal processor, or another hardware processing circuit. Alternatively, a “controller” can refer to a combination of a hardware processing circuit and machine-readable instructions (software and/or firmware) executable on the hardware processing circuit.

In some examples, a storage system may use metadata structures for processing inbound data streams (e.g., backup items). For example, such metadata structures may include data recipes (also referred to herein as “manifests”) that specify the order in which particular data units are received for each backup item. Further, such metadata structures may include item metadata to represent each received backup item (e.g., a data stream) in a deduplicated form. The item metadata may include identifiers for a set of manifests, and may indicate the sequential order of the set of manifests. The processing of each backup item may be referred to herein as a “backup process.” Subsequently, in response to a read request, the storage system may use the item metadata and the set of manifests to determine the received order of data units, and may thereby recreate the original data stream of the backup item. Accordingly, the set of manifests may be a representation of the original backup item. The manifests may include a sequence of records, with each record representing a particular set of data unit(s). The records of the manifest may include one or more fields that identify container indexes. The container indexes may be metadata structures that index (e.g., include storage information for) the data units. For example, a container index may include multiple entries, and each entry may include one or more metadata fields that specify location information (e.g., data containers, offsets, etc.) for the stored data units, compression and/or encryption characteristics of the stored data units, and so forth. Further, the container index may include reference counts that indicate the number of manifests that reference each data unit.

In some examples, upon receiving a data unit (e.g., in a data stream), it may be matched against one or more container indexes to determine whether an identical chunk is already stored in a container of the storage system. For example, the storage system may compare the fingerprint of the received data unit against the fingerprints in one or more container indexes. As used herein, the term “matching operation” may refer to an operation to compare fingerprints of a collection of multiple data units (e.g., from a particular backup data stream) against fingerprints stored in one or more container indexes. If no matching fingerprints are found in the searched container index(es), the received data unit may be added to a data container, and a metadata entry for the received data unit may be added to a container index corresponding to that container. However, if a matching fingerprint is found in a searched container index, it may be determined that a data unit identical to the received data unit is already stored in an existing data container. In response to this determination, the reference count of the corresponding entry may be incremented, and the received data unit is not stored in a data container (as it is already present in one of the data containers), thereby avoiding storing a duplicate data unit in the storage system.

In some examples, a deduplication storage system may store data units in container data objects included in a remote storage (e.g., a “cloud” or network storage service), rather than in a local filesystem. Further, in some examples, each container data object may be a container entity group (“CEG”) object that includes a particular number of data units (e.g., one thousand data units), or a particular data amount (e.g., ten megabytes). Each CEG object may be transferred to (or from) remote storage in a single transfer operation (e.g., as a single data object). For example, a single “GET” operation may be performed to retrieve a CEG object from the remote storage to memory, and a single “PUT” operation may be performed to transfer the CEG object from the memory to the remote storage.

In some examples, when new data units are identified (e.g., based on a matching operation), the new data units may be stored in a pending CEG object. As used herein, a “pending CEG object” may refer to a new CEG object that is generated in memory to store the new data units. Once the pending CEG object is full (e.g., stores a maximum number or amount of data unis), that pending CEG is written to storage, and a new pending CEG object may be generated in memory.

In some examples, container indexes may store metadata that “indexes” or describes the data units stored in the CEG objects. For example, each entry in a container index may record a data unit location as a combination of a CEG object identifier and an offset for the indexed data unit (in the identified CEG object). In another example, each entry may record a reference count that indicates the number of manifests that reference the indexed data unit. In such examples, when a data unit is no longer referenced by any manifest, the reference count for that data unit may be decremented to zero (also referred to herein as a “zero reference count”).

In some examples, when all data units in a particular CEG object have zero reference counts, all of the data units in that CEG object may be considered to be obsolete or invalid. Accordingly, that CEG object no longer includes any useful data units, and therefore that CEG object may be deleted. However, in some examples, a particular CEG object (also referred to herein as a “stale CEG object”) may include a relatively small number of data units that have positive reference counts (i.e., remain referenced by at least one manifest) for an extended period of time. In such examples, the stale CEG object may have to be kept stored in the remote storage for the extended period of time. As such, the stale CEG object may incur storage costs (e.g., storage fees charged by the remote storage service) for the extended period of time, where a majority of these storage costs are associated with the obsolete data units in the stale CEG object. Further, the transfer operations for that stale CEG object may incur transfer costs (e.g., transfer fees charged by the remote storage service) for the extended period of time, where a majority of these transfer costs are associated with the obsolete data units in the stale CEG object. Accordingly, such stale CEG objects may incur relatively high costs for storage and transfer of useless data units.

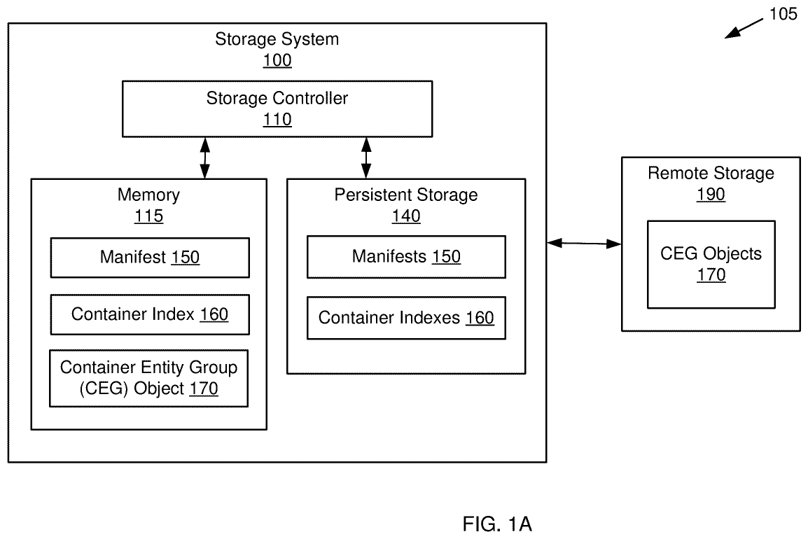

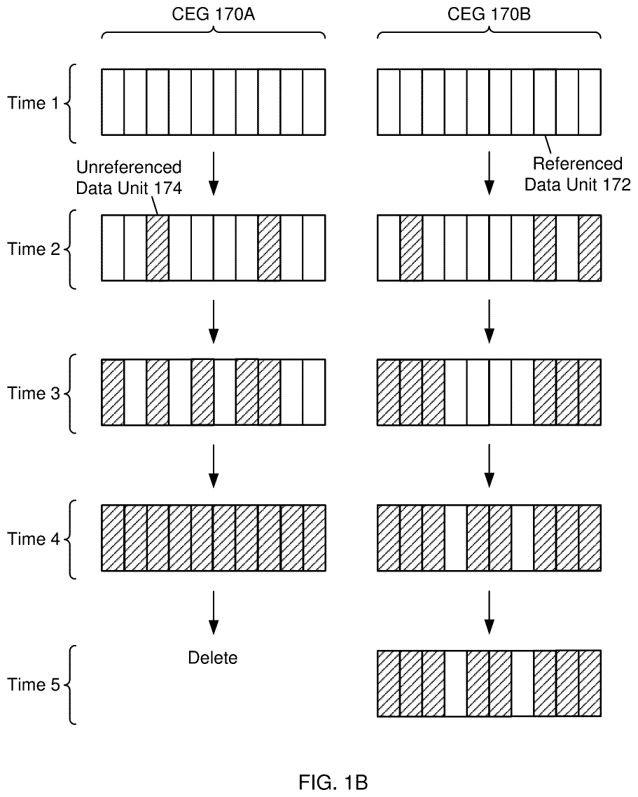

In accordance with some implementations of the present disclosure, a controller of a deduplication storage system may load a container index into memory, and may identify the existing CEG objects that are indexed by the container index. For each existing CEG object, the controller may determine the size (or number) of unreferenced data units (i.e., those having zero reference counts) that are included in that CEG object. If the size of unreferenced data units satisfies a rewrite threshold (e.g., is less than or equal to the threshold), the controller may move the referenced data units (i.e., those having reference counts greater than zero) from the existing CEG object to a pending CEG object. The controller may then update the container index to reflect the moved data units, and may then delete the existing CEG object. After processing all existing CEG objects, the controller may transfer the pending CEG object to the remote storage. In this manner, the stale CEG objects may be deleted from the storage system, thereby reducing the cost for storing and transferring CEG objects. The disclosed technique for housekeeping CEG objects is described further below with reference to FIGS. 1A-9.

### FIGS. 1A-1B—Example Storage System

FIG. 1A shows an example of a system 105 that includes a storage system 100 and a remote storage 190. The storage system 100 may include a storage controller 110, memory 115, and persistent storage 140, in accordance with some implementations. The storage system 100 may be coupled to the remote storage 190 via a network connection. The remote storage 190 may be a network-based persistent storage facility or service (also referred to herein as “cloud-based storage”). In some examples, use of the remote storage 190 may incur financial charges that are based on the number of individual transfers.

The persistent storage 140 (also referred to herein as “local storage”) may include one or more non-transitory storage media such as hard disk drives (HDDs), solid state drives (SSDs), optical disks, and so forth, or a combination thereof. The memory 115 may be implemented in semiconductor memory such as random access memory (RAM). In some examples, the storage controller 110 may be implemented via hardware (e.g., electronic circuitry) or a combination of hardware and programming (e.g., comprising at least one processor and instructions executable by the at least one processor and stored on at least one machine-readable storage medium).

As shown in FIG. 1A, the memory 115 and the persistent storage 140 may store various data structures including at manifests 150 and container indexes 160. In some examples, copies of the manifests 150 and the container indexes 160 may be transferred between the memory 115 and the persistent storage 140 (e.g., via read and write input/output (I/O) operations). The remote storage 190 may persistently store container entity group (“CEG”) objects 170. Each CEG object 170 may be a container data structure configured to store multiple data units.

In some implementations, the storage system 100 may perform deduplication of the stored data. For example, the storage controller 110 may divide a stream of input data into data units, and may include at least one copy of each data unit in at least one of the CEG objects 170. The storage controller 110 may generate a manifest 150 to record the order in which the data units were received in the data stream. The manifest 150 may include a pointer or other information indicating the container index 160 that is associated with each data unit. In some implementations, the container index 160 may indicate the location in which the data unit is stored. For example, the container index 160 may include information specifying that the data unit is stored at a particular offset in an entity, and that the entity is stored at a particular offset in a particular CEG object 170. Further, the container index 160 may include reference counts that indicate the number of manifests 150 that reference each data unit.

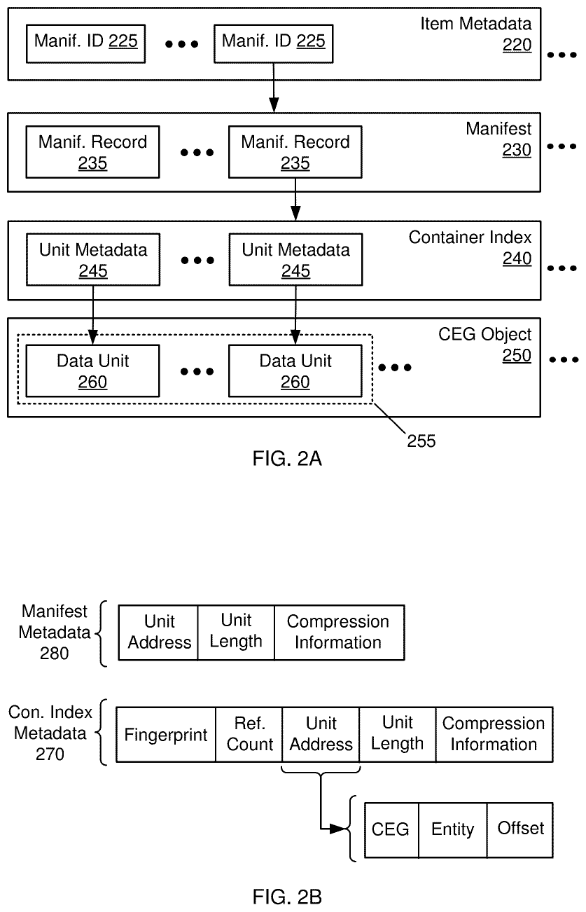

In some implementations, the storage controller 110 may generate a fingerprint for each received data unit. For example, the fingerprint may include a full or partial hash value based on the data unit. To determine whether an incoming data unit is a duplicate of a stored data unit, the storage controller 110 may perform a matching operation to compare the fingerprint generated for the incoming data unit to the fingerprints in at least one container index 160. If a match is identified in the matching operation, the storage controller 110 may determine that a duplicate of the incoming data unit is already stored by the storage system 100. The storage controller 110 may then store references to the previous data unit, instead of storing the duplicate incoming data unit. Otherwise, if no match is identified in the matching operation, the storage controller 110 may determine that the incoming data unit is a new data unit (i.e., is not already stored by the storage system 100). The storage controller 110 may then store a copy of the new data unit in a pending CEG object 170, and may index the new data unit in a container index 160. Further, when the pending CEG object 170 is full (i.e., stores a maximum capacity of data units), the full pending CEG object 170 may be written to storage, and a new pending CEG object 170 may be instantiated in memory to store any subsequent new data units. Example implementations of a manifest 150, a container index 160, and a CEG object 170 are discussed further below with reference to FIGS. 2A-2B.

In some implementations, the storage controller 110 may receive a read request to access the stored data, and in response may access metadata one or more manifests 150 to determine the sequence of data units that made up the original data. The storage controller 110 may then use pointer data included in a manifest 150 to identify the container indexes 160 that index the data units. Further, the storage controller 110 may use information included in the identified container indexes 160 to determine the locations that store the data units (e.g., CEG object 170, entity, offsets, etc.), and may then read the data units from the determined locations.

In some implementations, the storage controller 110 may update the manifests 150 and the container indexes 160 to reflect changes in the data stored in the storage system 100. For example, when a data unit is deleted from a given manifest 150 (e.g., due to a change to a data stream or backup item represented by the manifest 150), the storage controller 110 may decrement the reference count for that data unit by one (i.e., indicating that the data unit is referenced by one less manifest). Further, in such examples, the storage controller 110 may load a particular container index 160 into the memory 155 to decrement the reference count (in the container index 160) that is associated with that data unit. Furthermore, after the reference count is decremented, the storage controller 110 may write the updated container index 160 from the memory 115 to the persistent storage 150 (e.g., during a memory flush).

In some implementations, the reference counts of data units in the CEG objects 170 may change over time. For example, referring to FIG. 1B, shown are two example CEG objects 170A, 170B at various points in time. As shown, at a first point in time (“Time 1”), each of the CEG objects 170A, 170B stores a maximum number (e.g., ten) of referenced data units 172. As used herein, a “referenced data unit” is a data unit having a reference count (e.g., recorded in a container index 160) that is greater than zero, thereby indicating that the data unit is referenced in at least one manifest 150 that is active (i.e., is not marked for deletion). In the example shown in FIG. 1B, each referenced data unit 172 is illustrated as an empty rectangular block (i.e., with no fill).

At a second point in time (“Time 2”), the first CEG object 170A now includes two unreferenced data units 174 and eight referenced data units 172. Further, the second CEG object 170B includes three unreferenced data units 174 and seven referenced data units 172. As used herein, an “unreferenced data unit” is a data unit having a zero reference count (i.e., a reference count equal to zero), thereby indicating that the data unit is no longer referenced by any active manifest(s) 150. In the example shown in FIG. 1B, each unreferenced data unit 174 is illustrated as a rectangular block that is filled with diagonal hatching. At a third point in time (“Time 3”), the first CEG object 170A now includes five unreferenced data units 174 and five referenced data units 172. Further, the second CEG object 170B includes six unreferenced data units 174 and four referenced data units 172.

At a fourth point in time (“Time 4”), the first CEG object 170A includes ten unreferenced data units 174, and does not include any referenced data units 172. Further, the second CEG object 170B includes eight unreferenced data units 174 and two referenced data units 172. Upon determining that every data unit in the first CEG object 170A is an unreferenced data unit 174, the storage controller 110 determines that the first CEG object 170A only includes obsolete data. Accordingly, at a fifth point in time (“Time 5”), the storage controller 110 deletes the first CEG object 170A. However, as shown in FIG. 1B, the second CEG object 170B still includes two referenced data units 172 at the fifth point in time, and therefore the second CEG object 170B cannot be deleted. Further, in some examples, the second CEG object 170B may retain at least one referenced data unit 172 for an extended period of time. In such examples, if the second CEG object 170B is stored in the remote storage 190, the second CEG object 170B may incur substantial financial costs (e.g., for storage and transfer costs over the extended period of time).

In some implementations, the storage controller 110 may perform housekeeping operations to reduce or eliminate any stale CEG objects 170. The storage controller 110 may load a container index 160 into memory 115, and may identify a set of existing CEG objects 170 that are indexed by the container index 160. For each existing CEG object 170, the storage controller 110 may determine the size (or number) of unreferenced data units 174 that are included in that CEG object 170. If the size of unreferenced data units 174 satisfies a threshold (e.g., is less than or equal to the threshold), the storage controller 110 may move the referenced data units 172 from the existing CEG object 170 to a pending CEG object 170 in memory 115. Further, the storage controller 110 may update the container index 160 to reflect the new location of the moved referenced data units 172, and may delete the existing CEG object 170. After processing the some or all of the identified set of existing CEG objects 170, the storage controller 110 may transfer the pending CEG object 170 from memory 115 to the remote storage 190. In this manner, the stale CEG objects 170 may be deleted, thereby reducing the cost for storing and transferring CEG objects 170.

Further, in some implementations, the housekeeping operations for existing stale CEG objects 170 may be limited or controlled via a rewrite budget. For example, each pending CEG object 170 may be allocated a rewrite budget that is proportional to the amount of new data units that are already stored in that pending CEG object 170. The rewrite budget may limit the amount of referenced data units 172 that can be moved from one or more existing CEG objects 170 to the pending CEG object 170. For example, if the total size of the referenced data units 172 in an existing CEG object 170 is less than or equal to the rewrite budget, those referenced data units 172 may be moved to the pending CEG object 170, and the rewrite budget may be decreased by the size of the moved data units. Further, if the total size of the referenced data units 172 in the existing CEG object 170 exceeds the rewrite budget, those referenced data units 172 are not moved to the pending CEG object 170. In this manner, the rewrite budget may limit the total amount of data that can be moved from a set of existing CEG objects 170 to a pending CEG object 170, and may thereby provide control of the housekeeping operations of CEG objects 170.

Note that, while FIG. 1A shows one example, implementations are not limited in this regard. For example, it is contemplated that some or all of the manifests 150 and container indexes 160 may be stored in the remote storage 190. In another example, it is contemplated that some or all of the CEG objects 170 may be stored in the persistent storage 140. In yet another example, it is contemplated that the memory 115, persistent storage 140, and/or remote storage 190 may include other data objects or metadata. Further, it is contemplated that the storage system 100 may include additional devices and/or components, fewer components, different components, different arrangements, and so forth.

### FIGS. 2A-2B—Example Data Structures

FIG. 2A shows an illustration of example data structures 200 used in deduplication, in accordance with some implementations. As shown, the data structures 200 may include item metadata 220, a manifest 230, a container index 240, and a container entity group (“CEG”) object 250. In some examples, the manifest 230, the container index 240, and the CEG object 250 may correspond generally to example implementations of a manifest 150, a container index 160, and a CEG object 170 (shown in FIG. 1A), respectively. Further, in some examples, the data structures 200 may be generated and/or managed by the storage controller 110 (shown in FIG. 1A).

In some implementations, the item metadata 220 may include multiple manifests identifiers 225. Each manifests identifier 225 may identify a different manifest 230. In some implementations, the manifests identifiers 225 may be arranged in a stream order (i.e., based on the order of receipt of the data units represented by the identified manifests 230). Further, although one of each is shown for simplicity of illustration in FIG. 2A, data structures 200 may include a plurality of instances of item metadata 220, each including or pointing to one or more manifests 230. In such examples, data structures 200 may include a plurality of manifests 230. The manifests 230 may include a plurality of manifest records 235 that reference a plurality of container indexes 240. Each container index 240 may comprise a plurality of unit metadata 245. Each instance of unit metadata 245 may index one or more data units 260. Each CEG object 250 may comprise a plurality of data units 260. Further, in some examples, a CEG object 250 may include one or more groupings or “entities” 255, with each entity 255 including multiple data units 260.

Referring now to FIG. 2B, shown are container index metadata 270 and manifest metadata 280. In some implementations, the manifest metadata 280 may be included in a manifest 230 (e.g., in a manifest record 235). Further, the container index metadata 270 may be included in a container index 240 (e.g., in unit metadata 245).

In some implementations, the container index metadata 270 and the manifest metadata 280 may each include a unit address, a unit length, and compression information. The unit address may be information stored in a field (or in a combination of multiple fields) that deterministically identifies the storage location of one or more data units. Further, the unit length may specify the data length of the data unit(s) stored at the unit address.

As shown in FIG. 2B, in some implementations, the unit address of a data unit may be recorded as three values (e.g., stored in three fields) that respectively identify a CEG object 250, an entity 255 within the CEG object 250, and an offset within the entity 255. In other implementations, the unit address may be a numerical value (referred to as the “arrival number”) that indicates the sequential order of arrival (also referred to as the “ingest order”) of data units being added to a deduplication storage system (e.g., system 105 shown in FIG. 1A).

In some implementations, the container index metadata 270 and/or the manifest metadata 280 may use a run-length reference format to represent a continuous range of data units (e.g., a portion of a data stream) that is stored within a single CEG object 250 (or within a single entity 255). For example, a unit address field may record the offset (in a CEG object 250) for the start of a first data unit in the data range being represented, and the unit length field may indicate the length of the data range being represented.

In another example, a unit address field may record the arrival number of a first data unit in the data unit range being represented, and the unit length field may indicate a number N (where “N” is an integer) of data units, in the data unit range, that follow the first data unit specified by arrival number in the unit address field. The data units in a data unit range may have consecutive arrival numbers (e.g., because they are consecutive in an ingested data stream). As such, a data unit range may be represented by an arrival number of a first data unit in the data unit range (e.g., recorded in a unit address field) and a number N of further data units in the data unit range (e.g., recorded in a unit length field). The further data units in the data unit range after the first data unit may be deterministically derived by calculating the N arrival numbers that sequentially follow the specified arrival number of the first data unit, where those N arrival numbers identify the further data units in the data unit range. For example, the manifest metadata 280 may include an arrival number “X” in a unit address field and a number N in a unit length field, to indicate a data unit range including the first data unit specified by arrival number X and the following data units specified by arrival numbers X+i for i=1 through i=N, inclusive (where “i” is an integer). In this manner, the run-length reference format may be used to identify all data units in the data unit range.

In some implementations, the compression information may indicate how the stored data unit is compressed or decompressed (whether compression was used, type of compression code, type of decompression code, decompressed size, a checksum value, etc.). In some examples, during a read operation, the compression information may be used to decompress a requested data unit (or a particular entity 255 including the requested data unit).

In some implementations, the container index metadata 270 may include a fingerprint and a reference count. The fingerprint may be a value derived by applying a function (e.g., a hash function) to all or some of the content of the data unit. The reference count may indicate the total number of manifest records 235 (or manifests 230) that reference the data unit. Further, in some implementations, the fingerprint and a reference count may not be included in the manifest metadata 280.

Note that, while FIGS. 2A-2B show one example of the data structures 200, implementations are not limited in this regard. For example, it is contemplated that the item metadata 220, manifest 230, container index 240, and CEG object 250 may include additional fields or elements, additional data structures, and so forth. In another example, it is contemplated that the container index metadata 270 and/or the manifest metadata 280 may include additional fields or elements.

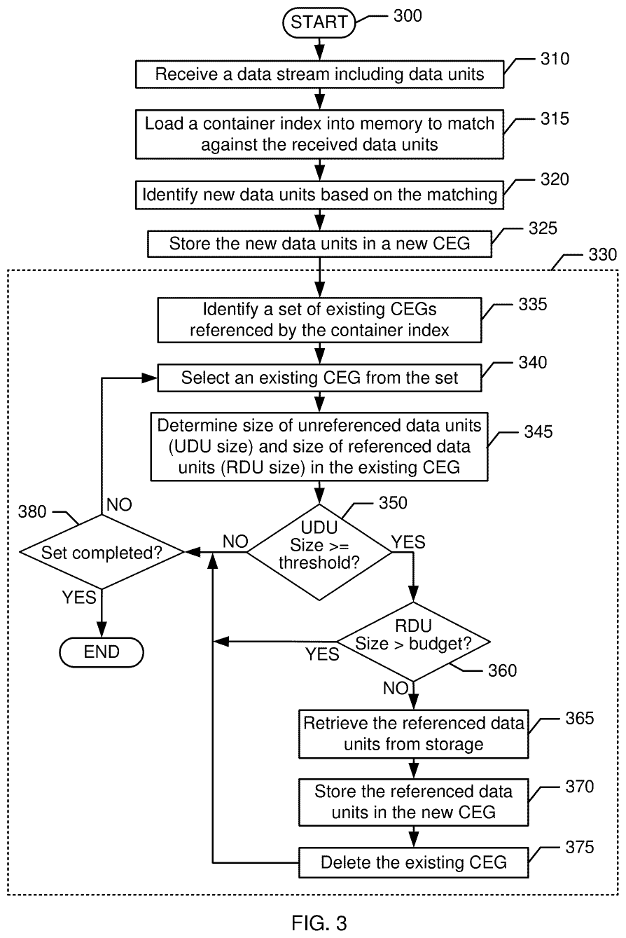

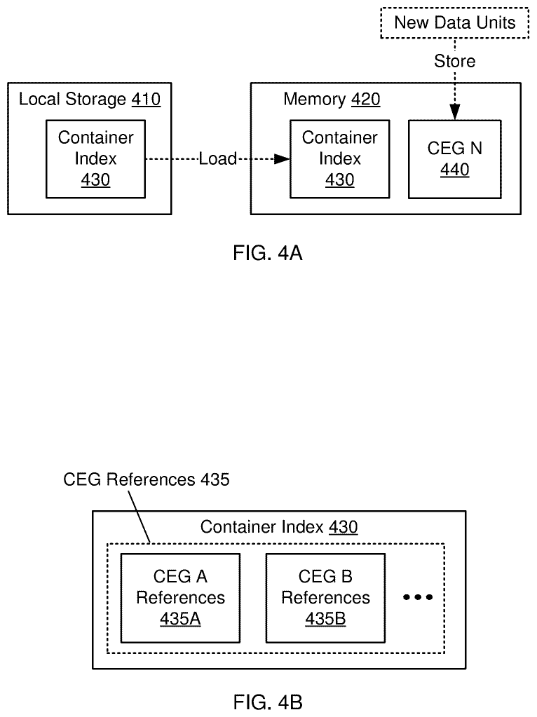

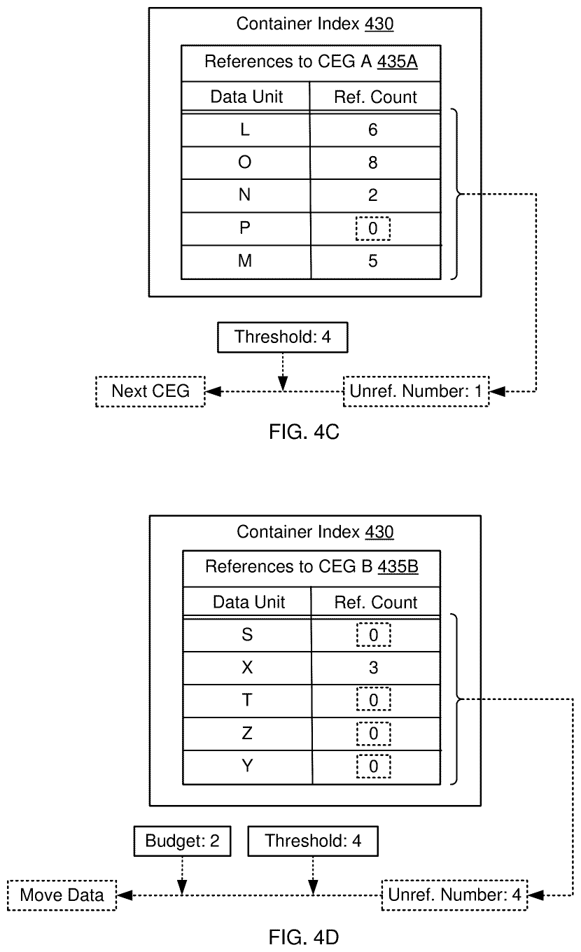

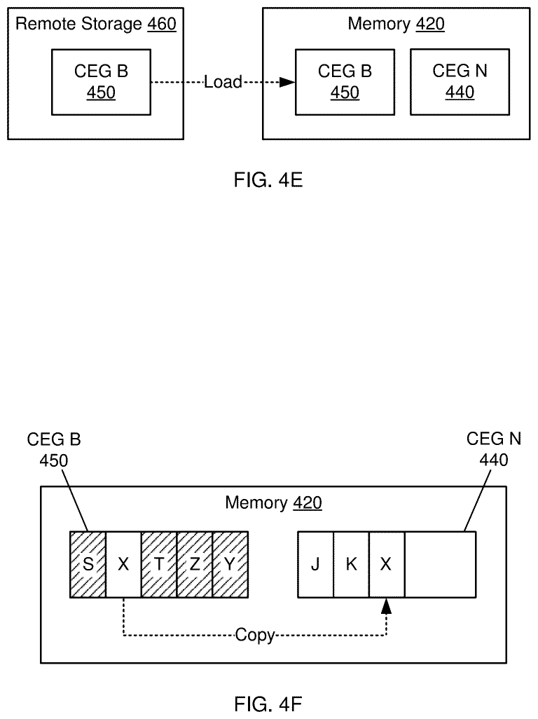

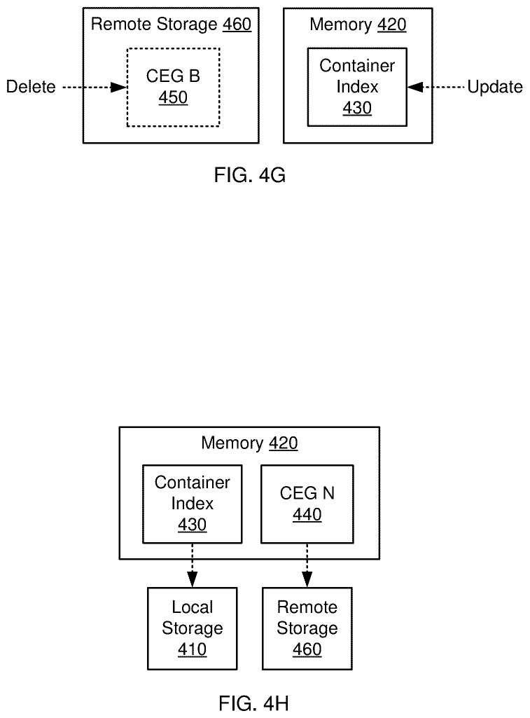

### FIGS. 3-4H—Example Process for Data Housekeeping

FIG. 3 shows an example process 300 for data housekeeping, in accordance with some implementations. For the sake of illustration, details of the process 300 may be described below with reference to FIGS. 4A-4H, which show examples in accordance with some implementations. However, other implementations are also possible. In some examples, the process 300 may be performed using the storage controller 110 (shown in FIG. 1A). The process 300 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth.

Block 310 may include receiving a data stream including data units. Block 315 may include loading a container index into memory to match against the received data units. Block 320 may include identifying new data units based on the matching. Block 325 may include storing the new data units in a new container entity group (“CEG”) object (e.g., a pending CEG object in memory).

For example, referring to FIG. 4A, a controller (e.g., storage controller 110 shown in FIG. 1A) receives data units to be stored in deduplicated form. The controller transfers a copy of a container index 430 from local storage 410 to memory 420 (e.g., via a read I/O operation) for a matching operation against the fingerprints of the received data units. Each unmatched fingerprint (i.e., a fingerprint that is not matched against the fingerprints stored in the container index 430) identifies a new data unit (i.e., a data unit that is not already stored in deduplicated form). The controller then stores the new data units in a pending CEG object “N” 440 (e.g., a CEG object that is generated in memory 420 to store new data units). Assume that, in the examples shown in FIGS. 4A-4H, all data units have the same stored size (referred to herein as one “standard unit size”). For example, each data unit stored in the pending CEG object “N” 440 may have a standard unit size of 1 kilobyte (KB).

Referring again to FIG. 3, after block 325, the process 300 may begin a housekeeping subprocess 330 (illustrated by a dotted-line box) that may include blocks 335-380. As shown in FIG. 3, block 335 may include identifying a set of existing CEG objects referenced by the container index (loaded in memory for the matching operation). Block 340 may include selecting an existing CEG object from the identified set of existing CEG objects.

For example, referring to FIG. 4B, the controller initiates a housekeeping process, and determines that the container index 430 includes a set of CEG references 435 (i.e., metadata that references CEG objects), including at least CEG object “A” references 435A and CEG object “B” references 435B. In some examples, the CEG references 435 may be included in unit metadata (e.g., unit metadata 245 shown in FIG. 2A) for data units that are stored in a particular CEG object (e.g., in a “Unit Address” field that identifies CEG object “A”). In the example illustrated in FIG. 4B, the controller may initially select the CEG object “A” (i.e., referenced by the CEG object “A” references 435A in the container index 430) to be processed for housekeeping.

Referring again to FIG. 3, block 345 may include determining the size of unreferenced data units (“UDU size”) in the existing CEG object and the size of referenced data units (“RDU size”) in the existing CEG object. Decision block 350 may include determining whether the size of unreferenced data units in the existing CEG object satisfies (e.g., is greater than or equal to) a threshold. Upon a negative determination at decision block 350 (“NO”), the process 300 may continue at decision block 380, including determining whether the set of existing CEG objects (identified at block 330) is complete. If so (“YES”), the process 300 may be completed (“END”). Otherwise, if it is determined at decision block 380 that the set of existing CEG objects is not complete (“NO”), the process 300 may return to block 335 (i.e., to select another existing CEG object from the identified set).

For example, referring to FIG. 4C, the controller reads the container index 430 to determine the reference counts for the data units included in the existing CEG object “A.” The controller determines that there is one unreferenced data unit in CEG object “A,” namely the data unit “P” that has a reference count equal to zero. Further, the controller determines that the size of unreferenced data units in CEG object “A” (i.e., one standard unit size) is less than a housekeeping threshold (i.e., four standard unit sizes). In response to this determination, the controller does not modify the CEG object “A,” and instead selects the next CEG object in the set (identified at block 330).

Referring again to FIG. 3, if it is determined at decision block 350 that the size of unreferenced data units in the existing CEG object satisfies (e.g., is greater than or equal to) the threshold (“YES”), the process 300 may continue at decision block 360, including determining whether the size of the referenced data units in the existing CEG object exceeds a rewrite budget. Upon a positive determination at decision block 360 (“YES”), the process 300 may return to decision block 380 (i.e., to determine whether the set of existing CEG objects has been completed). Otherwise, if it is determined at decision block 360 that the size of the referenced data units does not exceed the rewrite budget (“NO”), the process 300 may continue at block 365, including retrieving the referenced data units from storage. Block 370 may include storing the referenced data units in the new CEG object. Block 375 may include deleting the exiting CEG object. After block 375, the process 300 may return to decision block 380 (i.e., to determine whether the set of existing CEG objects has been completed).

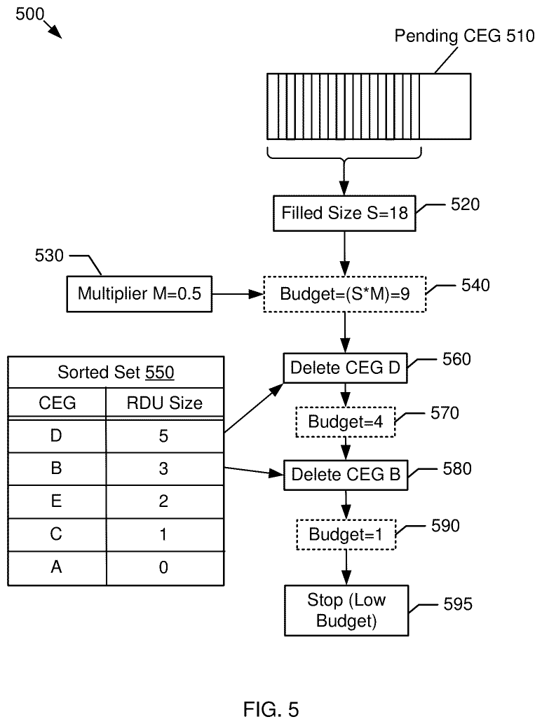

For example, referring to FIG. 4D, the controller reads the container index 430 to determine the reference counts for the data units included in the existing CEG object “B.” The controller determines that there are four unreferenced data units in CEG object “B” (i.e., data units “S,” “T,” “Z,” and “Y”), and there is one referenced data unit in CEG object “B” (i.e., data unit “X”). Further, the controller determines that the size of the unreferenced data units in the existing CEG object “B” (i.e., four standard unit sizes) satisfies the housekeeping threshold (i.e., four standard unit sizes). The controller then determines that the size of the unreferenced data unit “X” (i.e., one standard unit size) is less than the available rewrite budget (i.e., two standard unit sizes), and in response performs housekeeping for the exiting CEG object “B.” The controller then reduces the available rewrite budget by subtracting the size of the unreferenced data unit “X.” Accordingly, the remaining rewrite budget (i.e., the budget portion that is available for housekeeping the next CEG object in the set of CEG references 435) is equal to one standard unit size. An example process for determining the rewrite budget for housekeeping is described below with reference to FIG. 5.

Referring now to FIG. 4E, the controller causes the existing CEG object “B” 450 to be loaded from the remote storage 460 into the memory 420. Further, referring now to FIG. 4F, the controller determines that the data unit “X” is the only referenced data unit in the existing CEG object “B,” and copies the data unit “X” from the existing CEG object “B” to the new CEG object “N” 440.

Referring now to FIG. 4G, the controller deletes the existing CEG object “B” 450 from the remote storage 460 (and from memory 420). The controller also updates the container index 430 to indicate that data unit “X” is now stored in the new CEG object “N” 440. Further, referring now to FIG. 4H, the controller causes the container index 430 to be written from memory 420 to the local storage 410. Subsequently, after the housekeeping operation is completed (i.e., the set of existing CEG objects has been processed), or once the CEG object “N” 440 is filled to capacity, the controller causes the CEG object “N” 440 to be written from memory 420 to the remote storage 460.

Note that, while FIGS. 3-4H illustrate some examples, other implementations are possible. For example, while decision blocks 350 and 360 (in FIG. 3) respectively show determinations based on the sizes of unreferenced and referenced data units, it is contemplated that these determinations may instead be based on the numbers (i.e., quantities) of unreferenced and referenced data units, or any other similar values. In another example, regarding block 365, it is contemplated that the referenced data units may not be retrieved from remote storage in some examples. For example, the storage controller 110 may attempt to retrieve the referenced data units from a data source (e.g., a backup system or device that generates the data units received by the storage system 100) to avoid a transfer cost associated with retrieving the same data units from the remote storage 190. In yet another example, while FIGS. 4A-4H illustrate the housekeeping subprocess 330 as being performed after the intake of new data units, it is contemplated that the housekeeping subprocess 330 may also be performed as a separate process that is independent of data intake (e.g., in response to a user command). In still another example, it is contemplated that the container index 430 and the CEG object “N” 440 may both be written to the local storage 410, or may both be written to the remote storage 460.

### FIG. 5—Example Operation for Determining a Rewrite Budget

FIG. 5 shows an example operation 500 for determining a rewrite budget, in accordance with some implementations. In some examples, the operation 500 may be performed using the storage controller 110 (shown in FIG. 1A). The operation 500 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth.

In the example shown in FIG. 5, a pending container entity group (“CEG”) object 510 is loaded with new data units. At block 520, a controller (e.g., storage controller 110 shown in FIG. 1A) determines that the pending CEG object 510 stores 18 new data units, and therefore has a filled size S equal to 18 standard unit sizes.

The controller determines 530 that a rewrite multiplier M is equal to 0.5. In some implementations, the rewrite multiplier M may be a configuration setting or parameter of a storage system, and may be adjusted by a user or controller. At block 540, the controller multiplies the filled size S (i.e., 18) times the rewrite multiplier M (i.e., 0.5) to compute the rewrite budget 540 (i.e., 9).

The controller generates a sorted set 550 by identifying the CEG objects that are referenced by a container index (e.g., container index 430 shown in FIG. 4A), and sorting the identified CEG objects in descending order of size of referenced data units (“RDU Size”). For example, in the sorted set 550, the first-ordered CEG object D includes five referenced data units, the second-ordered CEG object B includes three referenced data units, and so forth.

At block 560, the controller performs housekeeping to delete the first-ordered CEG object D. For example, the controller performs process 300 (shown in FIG. 3), including determining (at decision block 350) that the size of unreferenced data units in CEG object D satisfies the threshold, and also determining (at decision block 360) that the size of the referenced data units in the CEG object D is smaller than the rewrite budget. After deleting the CEG object D, at block 570, the controller subtracts the RDU size of CEG object D (i.e., 5) from the rewrite budget (i.e., 9), thereby computing a new rewrite budget equal to 4.

Next, at block 580, the controller performs housekeeping to delete the second-ordered CEG object B. After deleting the CEG object B, at block 590, the controller subtracts the RDU size of CEG object B (i.e., 3) from the available rewrite budget (i.e., 4), thereby computing a new rewrite budget equal to 1.

Next, the controller attempts to perform housekeeping to delete the third-ordered CEG object E. However, at block 595, the controller compares the RDU size of CEG object E (i.e., 2) to the available rewrite budget (i.e., 1), and thereby determines that the rewrite budget is insufficient to perform housekeeping of the CEG object E (e.g., as shown in decision block 360 of FIG. 3). Accordingly, the controller stops the housekeeping process of the ordered set 550.

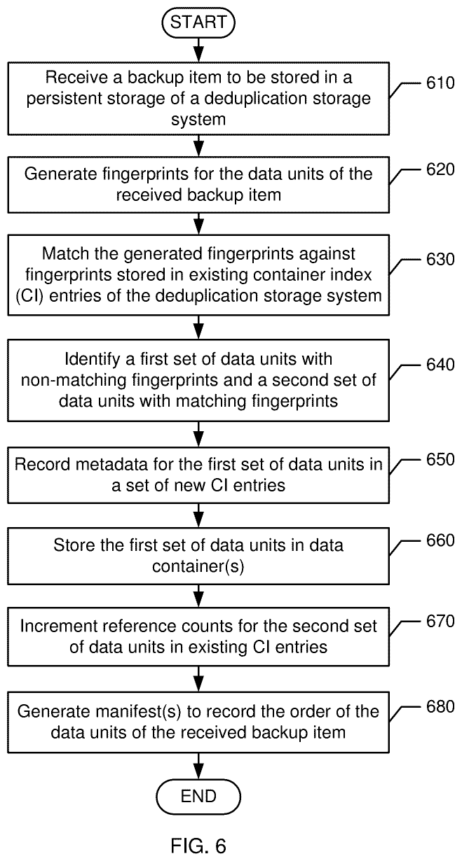

### FIG. 6—Example Process for Generating Metadata

FIG. 6 shows an example process 600 for generating metadata, in accordance with some implementations. For the sake of illustration, details of the process 600 may be described below with reference to FIG. 1A, which shows an example in accordance with some implementations. However, other implementations are also possible. In some examples, the process 600 may be performed using the storage controller 110 (shown in FIG. 1A). The process 600 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth.

Block 610 may include receiving a backup item to be stored in a persistent storage of a deduplication storage system. Block 620 may include generating fingerprints for the data units of the received backup item. Block 630 may include matching the generated fingerprints against fingerprints stored in existing container index (CI) entries of the deduplication storage system. Block 640 may include identifying a first set of data units with non-matching fingerprints and a second set of data units with matching fingerprints.

Block 650 may include recording metadata for the first set of data units in a set of new CI entries. Block 660 may include storing the first set of data units in one or more data containers. Block 670 may include incrementing reference counts for the second set of data units in existing CI entries. Block 680 may include generating one or more manifests to record the order of the data units of the received backup item.

For example, referring to FIG. 1A, the storage controller 110 receives a backup item to be stored in the deduplication storage system 100, and generates fingerprints for the data units in the received backup item. The storage controller 110 compares the generated fingerprints to the fingerprints included in container indexes 160. If a match is identified for a data unit, then the storage controller 110 determines that a duplicate of the data unit is already stored by the storage system 100. In response to this determination, the storage controller 110 stores a reference to the previous data unit (e.g., in a manifest 150) in deduplicated form. Otherwise, if a match is not identified for a data unit, then the storage controller 110 stores the data unit in a container entity group (“CEG”) object 170, and adds an entry for the data unit to a container index 160 corresponding to that CEG object 170. In some implementations, the storage controller 110 records the order in which data units are received in one or more manifests 150.

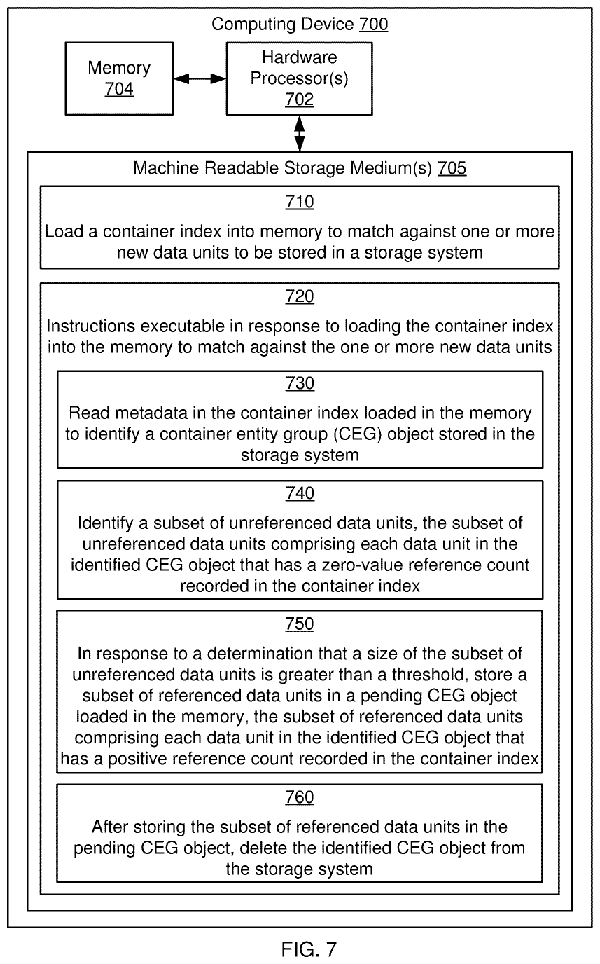

### FIG. 7—Example Computing Device

FIG. 7 shows a schematic diagram of an example computing device 700. In some examples, the computing device 700 may correspond generally to some or all of the storage system 100 (shown in FIG. 1A). As shown, the computing device 700 may include a hardware processor 702, a memory 704, and machine-readable storage 705 including instructions 710-760. The machine-readable storage 705 may be a non-transitory medium. The instructions 710-760 may be executed by the hardware processor 702, or by a processing engine included in hardware processor 702.

Instruction 710 may be executed to load a container index into memory to match against one or more new data units to be stored in a storage system. Instructions 720 may be executed in response to loading the container index into the memory to match against the one or more new data units. The instructions 720 may include instructions 730, 740, 750, and 760. Instruction 730 may be executed to read metadata in the container index loaded in the memory to identify a container entity group (CEG) object stored in the storage system. Instruction 740 may be executed to identify a subset of unreferenced data units, the subset of unreferenced data units comprising each data unit in the identified CEG object that has a zero-value reference count recorded in the container index. As used herein, a “zero-value reference count” is a reference count equal to zero.

Instruction 750 may be executed to, in response to a determination that a size of the subset of unreferenced data units is greater than a threshold, store a subset of referenced data units in a pending CEG object loaded in the memory, the subset of referenced data units comprising each data unit in the identified CEG object that has a positive reference count recorded in the container index. Instruction 760 may be executed to, after storing the subset of referenced data units in the pending CEG object, delete the identified CEG object from the storage system. As used herein, a “positive reference count” is a reference count (i.e., an integer) greater than zero.

For example, referring to FIG. 4A, a controller (e.g., storage controller 110 shown in FIG. 1A) receives data units to be stored in deduplicated form. The controller transfers a copy of a container index 430 from local storage 410 to memory 420 (e.g., via a read I/O operation) for a matching operation against the fingerprints of the received data units. The controller then stores the new data units in a pending CEG object “N” 440.

Referring now to FIG. 4B, in response to loading the container index 430 into memory 420 for the matching operation, the controller initiates a housekeeping process, and determines that the container index 430 includes a set of CEG references 435, including at least CEG object “A” references 435A and CEG object “B” references 435B. Referring now to FIG. 4D, the controller selects the CEG object “B” (e.g., in response to reading the CEG object “B” references 435B). The controller reads the container index 430 to determine the reference counts for the data units included in the existing CEG object “B.” The controller determines that there are four unreferenced data units in CEG object “B” (i.e., data units “S,” “T,” “Z,” and “Y”), and there is one referenced data unit in CEG object “B” (i.e., data unit “X”). Further, the controller determines that the size of the unreferenced data units in the existing CEG object “B” (i.e., four standard unit sizes) satisfies the housekeeping threshold (i.e., four standard unit sizes). The controller then determines that the size of the unreferenced data unit “X” (i.e., one standard unit size) is less than the available rewrite budget (i.e., two standard unit sizes), and in response performs housekeeping for the exiting CEG object “B.” The controller then reduces the available rewrite budget by subtracting the size of the unreferenced data unit “X.”

Referring now to FIG. 4E, the controller causes the existing CEG object “B” 450 to be loaded from the remote storage 460 into the memory 420. Further, referring now to FIG. 4F, the controller determines that the data unit “X” is the only referenced data unit in the existing CEG object “B,” and copies the data unit “X” from the existing CEG object “B” to the new CEG object “N” 440. Referring now to FIG. 4G, the controller deletes the existing CEG object “B” 450 from the remote storage 460 (and from memory 420). The controller also updates the container index 430 to indicate that data unit “X” is now stored in the new CEG object “N” 440. Further, referring now to FIG. 4H, the controller causes the container index 430 to be written from memory 420 to the local storage 410. Subsequently, after the housekeeping operation is completed (i.e., the set of existing CEG objects has been processed), or once the CEG object “N” 440 is filled to capacity, the controller causes the CEG object “N” 440 to be written from memory 420 to the remote storage 460.

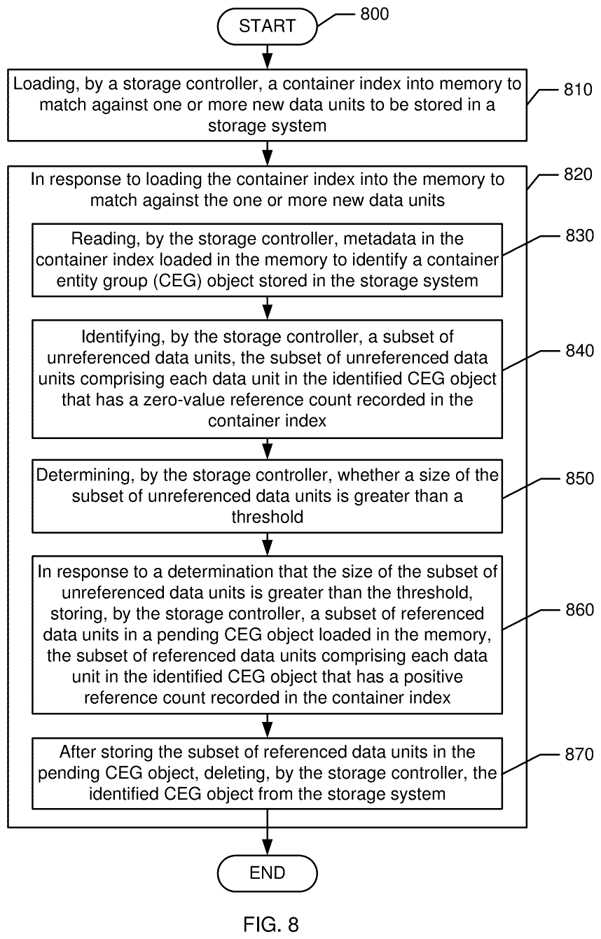

### FIG. 8—Example Process for Aggregating Data Units

FIG. 8 shows an example process 800 for aggregating data units, in accordance with some implementations. In some examples, the process 800 may be performed using the storage controller 110 (shown in FIG. 1A). The process 800 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth.

Block 810 may include loading, by a storage controller, a container index into memory to match against one or more new data units to be stored in a storage system. Blocks 820 may include multiple blocks (i.e., blocks 830, 840, 850, 860, and 870) that are performed in response to loading the container index into the memory to match against the one or more new data units.

Block 830 may include reading, by the storage controller, metadata in the container index loaded in the memory to identify a container entity group (CEG) object stored in the storage system. Block 840 may include identifying, by the storage controller, a subset of unreferenced data units, the subset of unreferenced data units comprising each data unit in the identified CEG object that has a zero-value reference count recorded in the container index.

Block 850 may include determining, by the storage controller, whether a size of the subset of unreferenced data units is greater than a threshold. Block 860 may include, in response to a determination that the size of the subset of unreferenced data units is greater than the threshold, storing, by the storage controller, a subset of referenced data units in a pending CEG object loaded in the memory, the subset of referenced data units comprising each data unit in the identified CEG object that has a positive reference count recorded in the container index. Block 870 may include, after storing the subset of referenced data units in the pending CEG object, deleting, by the storage controller, the identified CEG object from the storage system. Blocks 810-870 may correspond generally to the examples described above with reference to instructions 710-760 (shown in FIG. 7).

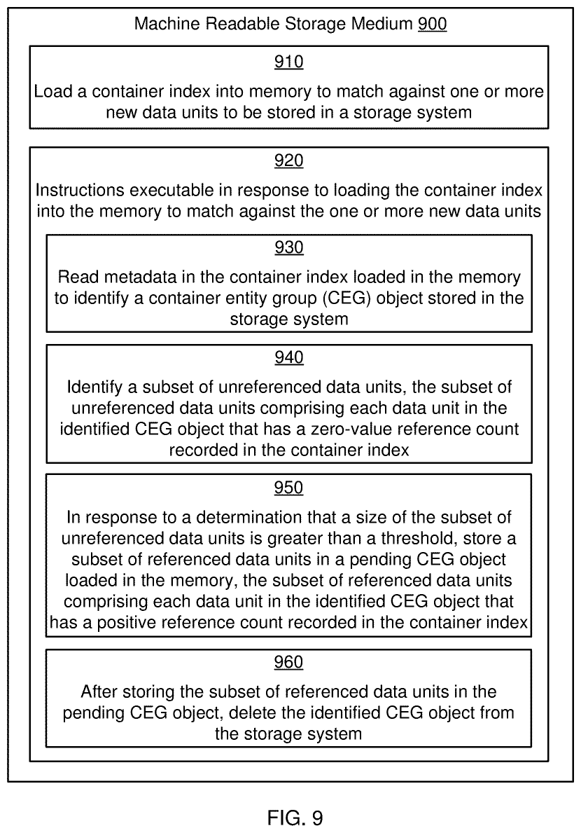

### FIG. 9—Example Machine-Readable Storage Medium

FIG. 9 shows a machine-readable storage medium 900 including instructions 910-960, in accordance with some implementations. The instructions 910-960 can be executed by a single processor, multiple processors, a single processing engine, multiple processing engines, and so forth. The machine-readable medium 900 may be a non-transitory storage medium, such as an optical, semiconductor, or magnetic storage medium. The instructions 910-960 may correspond generally to the examples described above with reference to instructions 710-760.

Instruction 910 may be executed to load a container index into memory to match against one or more new data units to be stored in a storage system. Instructions 920 may be executed in response to loading the container index into the memory to match against the one or more new data units. The instructions 920 may include instructions 930, 940, 950, and 960. Instruction 930 may be executed to read metadata in the container index loaded in the memory to identify a container entity group (CEG) object stored in the storage system. Instruction 940 may be executed to identify a subset of unreferenced data units, the subset of unreferenced data units comprising each data unit in the identified CEG object that has a zero-value reference count recorded in the container index.

Instruction 950 may be executed to, in response to a determination that a size of the subset of unreferenced data units is greater than a threshold, store a subset of referenced data units in a pending CEG object loaded in the memory, the subset of referenced data units comprising each data unit in the identified CEG object that has a positive reference count recorded in the container index. Instruction 960 may be executed to, after storing the subset of referenced data units in the pending CEG object, delete the identified CEG object from the storage system.

### Conclusion

In accordance with some implementations of the present disclosure, a controller of a storage system may load a container index into memory, and may identify the existing container entity group (CEG) objects that are indexed by the container index. For each existing CEG object, the controller may determine the size (or number) of unreferenced data units that are included in that CEG object. If the size of unreferenced data units satisfies a rewrite threshold, the controller may move the referenced data units from the existing CEG object to a pending CEG object. The controller may then update the container index to reflect the moved data units, and may then delete the existing CEG object. After processing all existing CEG objects, the controller may transfer the pending CEG object to the remote storage. In this manner, the stale CEG objects may be deleted, thereby reducing the cost for storing and transferring CEG objects.

Note that, while FIGS. 1A-9 show various examples, implementations are not limited in this regard. For example, referring to FIG. 1A, it is contemplated that the storage system 100 may include additional devices and/or components, fewer components, different components, different arrangements, and so forth. In another example, it is contemplated that the functionality of the storage controller 110 described above may be included in any another engine or software of storage system 100. Other combinations and/or variations are also possible.

Data and instructions are stored in respective storage devices, which are implemented as one or multiple computer-readable or machine-readable storage media. The storage media include different forms of non-transitory memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices.

Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

1. A computing device comprising:
at least one processor;
a memory; and
at least one machine-readable storage medium comprising instructions executable by the at least one processor to:
load a container index into the memory to match against one or more new data units to be stored in a storage system;
in response to loading the container index into the memory to match against the one or more new data units:
read metadata in the container index loaded in the memory to identify a container entity group (CEG) object stored in the storage system;
identify a subset of unreferenced data units, the subset of unreferenced data units comprising each data unit in the identified CEG object that has a zero-value reference count recorded in the container index;
in response to a determination that a size of the subset of unreferenced data units is greater than a threshold, store a subset of referenced data units in a pending CEG object loaded in the memory, the subset of referenced data units comprising each data unit in the identified CEG object that has a positive reference count recorded in the container index; and
after storing the subset of referenced data units in the pending CEG object, delete the identified CEG object from the storage system.

2. The computing device of claim 1, including instructions executable by the at least one processor to, in response to the determination that the size of the subset of unreferenced data units is greater than the threshold:
determine whether a size of the subset of referenced data units is greater than a rewrite budget of the identified CEG object;
in response to a determination that the size of the subset of referenced data units is not greater than the rewrite budget:
store the subset of referenced data units in the pending CEG object loaded in the memory; and
after storing the subset of referenced data units in the pending CEG object, delete the identified CEG object from the storage system.

3. The computing device of claim 2, including instructions executable by the at least one processor to, prior to storing the subset of referenced data units in the pending CEG object:
store the one or more new data units in the pending CEG object loaded in the memory.

4. The computing device of claim 3, including instructions executable by the at least one processor to, prior to storing the subset of referenced data units in the pending CEG object:
determine a size of the one or more new data units stored in the pending CEG object; and
calculate the rewrite budget as a product of a rewrite multiplier times the determined size of the one or more new data units.

5. The computing device of claim 4, wherein:
the storage system is a remote storage system that is coupled to the computing device via a network connection; and
the rewrite multiplier is a configuration setting of the computing device.

6. The computing device of claim 2, including instructions executable by the at least one processor to, after storing the subset of referenced data units in the pending CEG object
subtract the size of the subset of referenced data units from the rewrite budget.

7. The computing device of claim 2, including instructions executable by the at least one processor to:
in response to a determination that the size of the subset of referenced data units is greater than the rewrite budget, keep the identified CEG object stored in the storage system.

8. The computing device of claim 1, including instructions executable by the at least one processor to:
in response to a determination that the size of the subset of unreferenced data units is less than the threshold, keep the identified CEG object stored in the storage system.

9. The computing device of claim 1, including instructions executable by the at least one processor to:
update the container index to indicate that each of the subset of referenced data units is stored in the pending CEG object.

10. A method comprising:
loading, by a storage controller, a container index into memory to match against one or more new data units to be stored in a storage system;
in response to loading the container index into the memory to match against the one or more new data units:
reading, by the storage controller, metadata in the container index loaded in the memory to identify a container entity group (CEG) object stored in the storage system;
identifying, by the storage controller, a subset of unreferenced data units, the subset of unreferenced data units comprising each data unit in the identified CEG object that has a zero-value reference count recorded in the container index;
in response to a determination that a size of the subset of unreferenced data units is greater than a threshold, storing, by the storage controller, a subset of referenced data units in a pending CEG object loaded in the memory, the subset of referenced data units comprising each data unit in the identified CEG object that has a positive reference count recorded in the container index; and
after storing the subset of referenced data units in the pending CEG object, deleting, by the storage controller, the identified CEG object from the storage system.

11. The method of claim 10, comprising, in response to the determination that the size of the subset of unreferenced data units is greater than the threshold:
determining whether a size of the subset of referenced data units is greater than a rewrite budget of the identified CEG object;
in response to a determination that the size of the subset of referenced data units is not greater than the rewrite budget:
storing the subset of referenced data units in the pending CEG object loaded in the memory; and
after storing the subset of referenced data units in the pending CEG object, deleting the identified CEG object from the storage system.

12. The method of claim 11, comprising, prior to storing the subset of referenced data units in the pending CEG object:
storing the one or more new data units in the pending CEG object loaded in the memory.

13. The method of claim 12, comprising, prior to storing the subset of referenced data units in the pending CEG object:
determining a size of the one or more new data units stored in the pending CEG object; and
calculating the rewrite budget as a product of a rewrite multiplier times the determined size of the one or more new data units.

14. The method of claim 10, comprising:
updating the container index to indicate that each of the subset of referenced data units is stored in the pending CEG object.

15. A non-transitory machine-readable storage medium comprising instructions executable by at least one processor to:
load a container index into a memory to match against one or more new data units to be stored in a storage system;
in response to loading the container index into the memory to match against the one or more new data units:
read metadata in the container index loaded in the memory to identify a container entity group (CEG) object stored in the storage system;
identify a subset of unreferenced data units, the subset of unreferenced data units comprising each data unit in the identified CEG object that has a zero-value reference count recorded in the container index;
in response to a determination that a size of the subset of unreferenced data units is greater than a threshold, store a subset of referenced data units in a pending CEG object loaded in the memory, the subset of referenced data units comprising each data unit in the identified CEG object that has a positive reference count recorded in the container index; and
after storing the subset of referenced data units in the pending CEG object, delete the identified CEG object from the storage system.

16. The non-transitory machine-readable medium of claim 15, including instructions executable by the at least one processor to, in response to the determination that the size of the subset of unreferenced data units is greater than the threshold:
determine whether a size of the subset of referenced data units is greater than a rewrite budget of the identified CEG object;
in response to a determination that the size of the subset of referenced data units is not greater than the rewrite budget:
store the subset of referenced data units in the pending CEG object loaded in the memory; and
after storing the subset of referenced data units in the pending CEG object, delete the identified CEG object from the storage system.

17. The non-transitory machine-readable medium of claim 16, including instructions executable by the at least one processor to, prior to storing the subset of referenced data units in the pending CEG object:
store the one or more new data units in the pending CEG object loaded in the memory;
determine a size of the one or more new data units stored in the pending CEG object; and
calculate the rewrite budget as a product of a rewrite multiplier times the determined size of the one or more new data units.

18. The non-transitory machine-readable medium of claim 16, including instructions executable by the at least one processor to, after storing the subset of referenced data units in the pending CEG object
subtract the size of the subset of referenced data units from the rewrite budget.

19. The non-transitory machine-readable medium of claim 16, including instructions executable by the at least one processor to:
in response to a determination that the size of the subset of referenced data units is greater than the rewrite budget, keep the identified CEG object stored in the storage system.

20. The non-transitory machine-readable medium of claim 15, including instructions executable by the at least one processor to:
update the container index to indicate that each of the subset of referenced data units is stored in the pending CEG object.
